(19) United States
(12) Patent Application Publication
(10) Pub. No.: US 2013/0284879 A1
(43) Pub. Date: Oct. 31, 2013

(54) ASSEMBLY, A SUPPORT AND A METHOD FOR CARRYING A PERIPHERAL DEVICE

(71) Applicants: Long Chye Low, Singapore (SG); Wei Fuh Teo, Singapore (SG); Chee Leng Ng, Singapore (SG); Nicholas Stephen Marchland, Singapore (SG)

(72) Inventors: Long Chye Low, Singapore (SG); Wei Fuh Teo, Singapore (SG); Chee Leng Ng, Singapore (SG); Nicholas Stephen Marchland, Singapore (SG)

(73) Assignee: CREATIVE TECHNOLOGY LTD, Singapore (SG)

(21) Appl. No.: 13/978,381

(22) PCT Filed: Dec. 23, 2011
(86) PCT No.: PCT/SG2011/000450

§ 371 Date: Jul. 3, 2013

(30) Foreign Application Priority Data
Jan. 3, 2011 (SG) 201100001-5

(51) Int. Cl. F16M 11/00; F16M 13/02

(52) U.S. Cl. CPC F16M 11/00; F16M 13/02
USPC 248/558

(57) ABSTRACT

An assembly, a support and a method for carrying a peripheral device. The assembly is configurable for carrying a peripheral device in one of a stand configuration and a grip configuration. When in the stand configuration, the assembly is capable of supporting the peripheral device in a manner so as to elevate the peripheral device from a substantially horizontal surface. When in the grip configuration, the assembly is capable of supporting the peripheral device in a manner so as flexibly attach the peripheral device to an elevated surface. The assembly includes a support configurable for carrying the peripheral device. The support includes a base portion and a body portion.

### FIELD OF INVENTION

The present disclosure generally relates to an assembly, a support and a method for carrying a peripheral device. More particularly, various embodiments of the disclosure relate to an assembly, a support and a method for carrying a peripheral device in a manner so as to one of elevate the peripheral device from a horizontal surface and attach the peripheral device to an elevated surface.

### BACKGROUND

Peripheral devices such as webcams, video cameras, microphones and speakers can generally be used in various applications such that online chatting based applications.

For example, an internet user can use a webcam to stream video onto the World Wide Web (WWW). Specifically where an internet user does on-line chatting with another internet user, either one or both users may wish to stream videos pertaining to themselves or their surroundings onto the WWW during the chat.

In this regard, positioning the webcam in accordance with individual preference may generally be desired by a user, such as the aforementioned internet user. Thus a webcam needs to be suitably supported in a manner such that positioning of the webcam in accordance with individual preference can be achieved.

Conventional techniques for supporting a webcam include providing a stand for supporting the webcam on a horizontal surface such as a tabletop. Conventional techniques for supporting a webcam can further include providing a clip-on type support for supporting the webcam to, for example, a computer screen.

However, a clip-on type support for supporting a webcam to a computer screen of a particular shape or size may not be suitable for supporting the webcam to another computer screen of another shape or size. Thus conventional techniques fail to facilitate support of a webcam in an efficient manner.

Moreover, depending on whether support of the webcam is desired on a tabletop or a computer screen, a user may be required to change the support for the webcam accordingly. Thus conventional techniques may not be capable of facilitating support of a webcam in a user friendly manner.

It is therefore desirable to provide a solution to address at least one of the foregoing problems of conventional techniques.

### SUMMARY OF THE INVENTION

In accordance with one aspect of the disclosure, an assembly which is configurable for carrying a peripheral device in one of a stand configuration and a grip configuration is provided.

When in the stand configuration, the assembly is capable of supporting the peripheral device in a manner so as to elevate the peripheral device from a substantially horizontal surface. When in the grip configuration, the assembly is capable of supporting the peripheral device in a manner so as flexibly attach the peripheral device to an elevated surface.

The assembly includes a support configurable for carrying the peripheral device. The support includes a base portion and a body portion.

The base portion includes a first end and a second end opposing the first end. The body portion can be coupled to the base portion such that the body and base portions can be rotated relative to each other. The body portion includes a first body portion and a second body portion. The first body portion and the second body portion can be coupled to each other such that they can be rotated relative to each other. Furthermore, the first body portion can be coupled to the first end of base portion such that they can rotate relative to each other.

When in the stand configuration, the assembly is configurable such that the support is capable of supporting the peripheral device in a manner so as to elevate the peripheral device from the horizontal surface and the base portion contacts the horizontal surface.

When in the grip configuration, the assembly is configurable such that the support contacts the elevated surface via at least one of a first contact point, a second contact point and a third contact point.

In accordance with another aspect of the disclosure, a support configurable for carrying a peripheral device is provided. The support can be configured in a manner so as one of elevate the peripheral device from a substantially horizontal surface and flexibly attach the peripheral device to an elevated surface.

The support includes a base portion and a body portion. The base portion can be coupled to the body portion such that they can be rotated relative to each other.

The base portion includes a first end and a second end. The first and second ends oppose each other.

The body portion includes a first body portion and a second body portion. The first and second body portions can be coupled to each other such that they can be rotated relative to each other. Additionally, the first body portion can be coupled to the first end of base portion such that they can be rotated relative to each other.

When the peripheral device is elevated from the horizontal surface, the base portion contacts the horizontal surface.

When the peripheral device is flexibly attached to the elevated surface, the support contacts the elevated surface via at least one of a first contact point, a second contact point and a third contact point.

In accordance with yet another aspect of the disclosure, a support configurable for carrying a peripheral device is provided. The support can be configured to carry the peripheral device in a manner so as one of elevate the peripheral device from a substantially horizontal surface and flexibly attach the peripheral device to an elevated surface.

The support includes a base portion, a body portion and a carrying portion. The base portion can be coupled to the body portion via a first pivot joint such that they can be rotated relative to each other.

The base portion includes a first end and a second end. The first and second ends oppose each other.

The body portion includes a first body portion and a second body portion. The first and second body portions can be coupled to each other via a second pivot joint such that they can be rotated relative to each other. Additionally, the first body portion can be coupled to the first end of base portion such that they can be rotated relative to each other.

The carrying portion coupled to the second body portion via a third pivot joint in a manner such that the carrying portion is rotatable relative to the second body portion.

When the peripheral device is elevated from the horizontal surface, the base portion contacts the horizontal surface.

When the peripheral device is flexibly attached to the elevated surface, at least one of the first pivot joint, the second pivot joint and the second end of the base portion contact the elevated surface.

### BRIEF DESCRIPTION OF THE DRAWINGS

Embodiments of the disclosure are described hereinafter with reference to the following drawings, in which:

FIG. 1a and FIG. 1b show an assembly which includes a support which can be suitably configured to carry a peripheral device, according to an embodiment of the disclosure;

FIG. 2a shows a stand configuration of the assembly of FIG. 1a and FIG. 1b, according to an embodiment of the disclosure;

FIG. 2b shows a grip configuration of the assembly of FIG. 1a and FIG. 1b, according to an embodiment of the disclosure;

FIG. 3a shows a first exemplary grip position in association with the grip configuration of FIG. 2b, in accordance with an embodiment of the disclosure;

FIG. 3b shows a second exemplary grip position in association with the grip configuration of FIG. 2b, in accordance with an embodiment of the disclosure;

FIG. 3c shows a third exemplary grip position in association with the grip configuration of FIG. 2b, in accordance with an embodiment of the disclosure;

FIG. 3d shows a fourth exemplary grip position in association with the grip configuration of FIG. 2b, in accordance with an embodiment of the disclosure;

FIG. 3e and FIG. 3f show a fifth exemplary grip position in association with the grip configuration of FIG. 2b, in accordance with an embodiment of the disclosure; and

FIG. 4 is a flow diagram illustrating a method which can be implemented in association with the assembly of FIG. 1a and FIG. 1b, in accordance with another embodiment of the disclosure.

### DETAILED DESCRIPTION

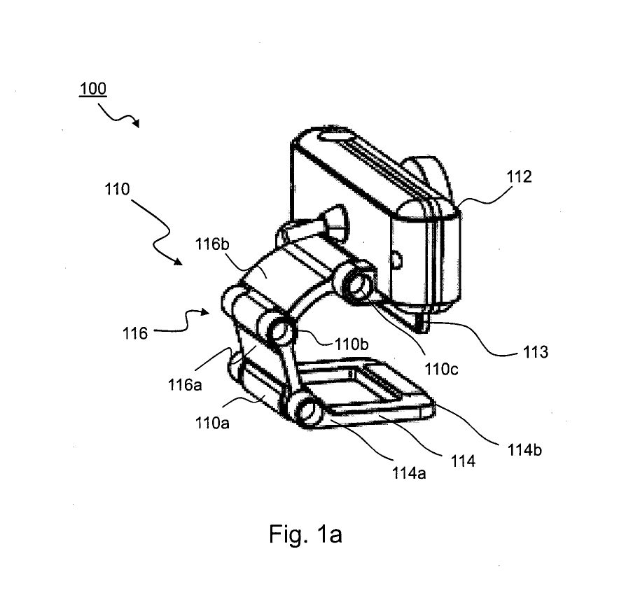

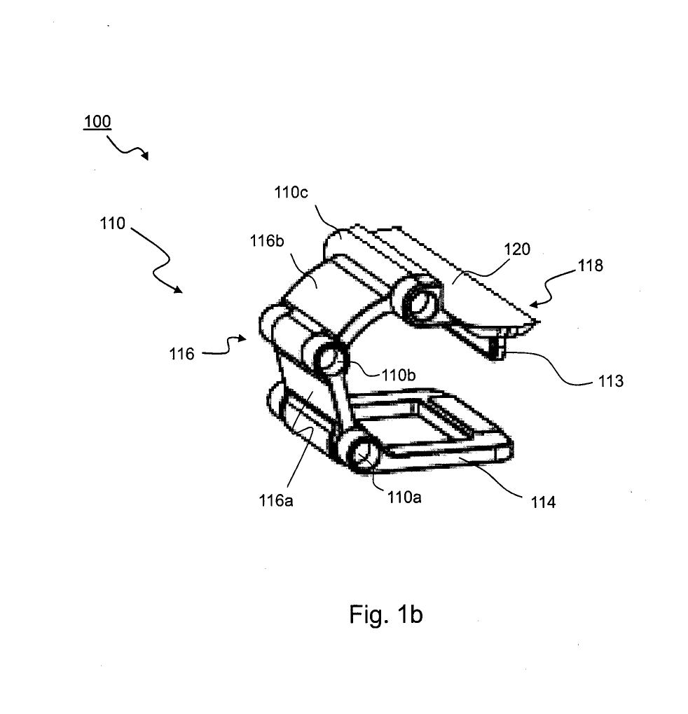

Representative embodiments of the disclosure, for addressing one or more of the foregoing problems associated with conventional techniques, are described hereinafter with reference to FIG. 1 to FIG. 4.

An assembly 100 is shown in FIG. 1a and FIG. 1b, in accordance with an embodiment of the disclosure.

The assembly 100 includes a support 110 which can be suitably configured to carry a peripheral device. An example of the peripheral device can be an image capturing device such as a webcam 112. Further examples of the peripheral device can include another image capturing device such as a video camera. Yet further examples of the peripheral device can include an audio device such as a microphone, a microphone array, a speaker or a speaker array. The assembly 100 further includes an anchor portion 113 which can be coupled to either the support 110 or the webcam 112, as will be discussed later in further detail.

The support 110 can include a base portion 114 and a body portion 116. The body portion 116 can include a first body portion 116a and a second body portion 116b. The support 110 can further include a carrying portion 118 having a platform portion 120. The carrying portion 118 can be coupled to the body portion 116. The anchor portion 113 can be coupled to one of the webcam 112 and the platform portion 120.

The webcam 112 can be coupled to the support 110 via one of the body portion 116 and the carrying portion 118, as will be discussed in further detail with reference to FIG. 1a and FIG. 1b respectively.

The base portion 114 can include a first end 114a and a second end 114b. The first end 114a opposes the second end 114b. The base portion 114 can be coupled to the body portion 116 in a manner such that the base portion 114 can be rotated with respect to the body portion 116. Specifically, the first body portion 116a can be coupled to the base portion 114 in a manner such that the base portion 114 is rotatable relative to the first body portion 116a. More specifically, the first body portion 116a can be coupled to the first end 114a such that the base portion 114 is rotatable relative to the first body portion 116a.

The first and second body portions 116a/116b can be coupled to each other in a manner such that they can be rotated relative to each other.

The second body portion 116b can be coupled to one of the webcam 112 and the carrying portion 118 in a manner such that the webcam 112 and the carrying portion 118 can be rotated relative to the second body portion 116b.

In this regard, the support 110 can include a first pivot joint 110a via which the base portion 114 can be coupled to the first body portion 116a. The support 110 can further include a second pivot joint 110b via which the first body and second body portions 116a/116b are coupled. The support 110 can yet further include a third pivot joint 110c via which the second body portion 116b can be coupled to either the webcam 112 or the carrying portion 118.

In one embodiment, as shown in FIG. 1a, the carrying portion 118 can be omitted. In this regard, the webcam 112 can be coupled to the body portion 116. Specifically, the webcam 112 can be coupled to the second body portion 116b via the third pivot joint 110c in a manner such that the webcam 112 is rotatable relative to the second body portion 116b. Additionally, the anchor portion 113 can be coupled to the webcam 112.

In another embodiment, as shown in FIG. 1b, the support 110 includes the carrying portion 118. In this regard, the webcam 112 can be coupled to the carrying portion 118. Specifically, the webcam 112 can be coupled to the platform portion 120. The anchor portion 113 can be coupled to the carrying portion 118. Additionally, the carrying portion 118 can be coupled to the second body portion 116b via the third pivot joint 110c in a manner such that the carrying portion 118 is rotatable relative to the second body portion 116b.

Furthermore, the carrying portion 118 can be configured such that distance between the anchor portion 113 and the third pivot joint 110c is adjustable. For example, the carrying portion 118 can be configured such that the platform portion 120 is of a sliding arrangement. More specifically, the platform portion 120 can include a first part (not shown) and a second part (not shown). The first part can be coupled to the third pivot joint 110c and the anchor portion 113 can be coupled to the second part. The first and second parts can be telescopically coupled such that the second part can slide to or from the first part. In this manner, the carrying portion 118 can, for example, be configured such that distance between the anchor portion 113 and the third pivot joint 110c is adjustable.

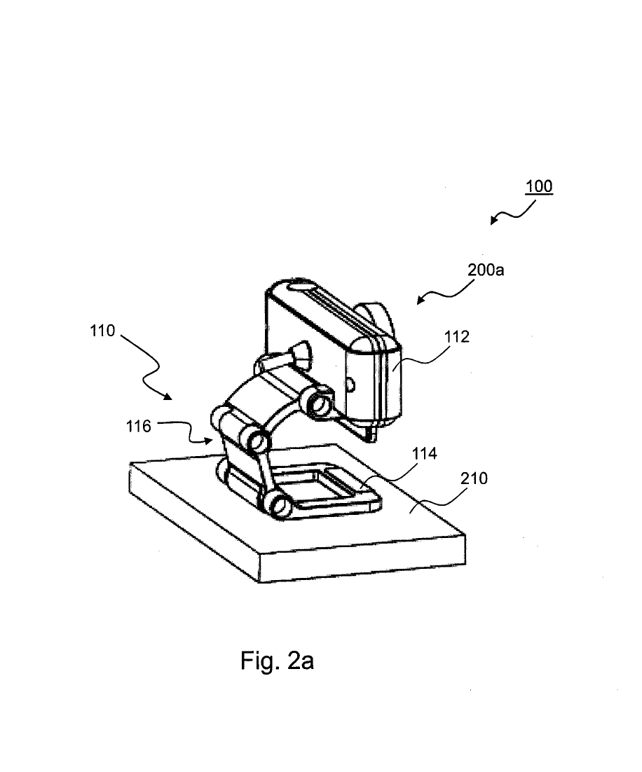

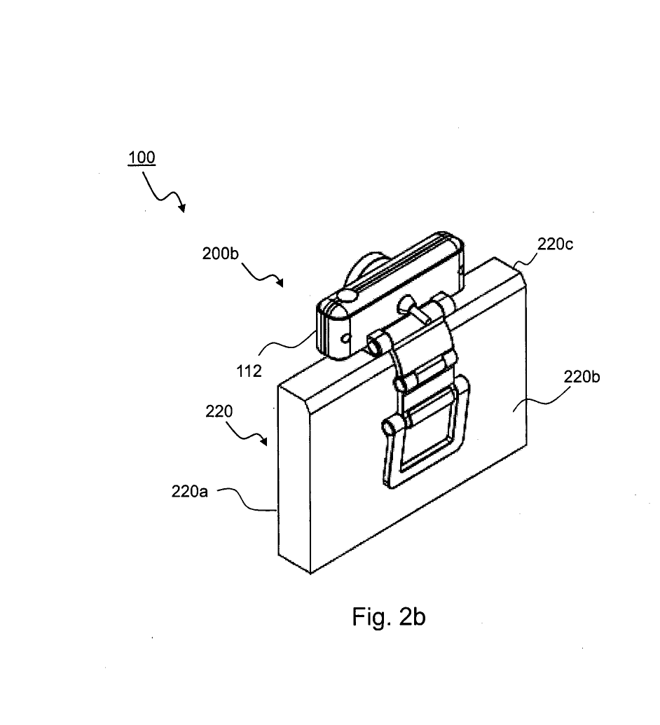

Referring to FIG. 2a and FIG. 2b, the assembly 100 can be in various configurations.

In one example, as shown in FIG. 2a, the assembly 100 can be in a stand configuration 200a such that the support 110 elevates the webcam 112 from a surface 210. The surface 210 can be a non-elevated surface which is substantially horizontal. In general, the support 110 contacts the surface 210 via the base portion 114 and the body portion 116 can be configured to elevate the webcam 112 from the surface 210.

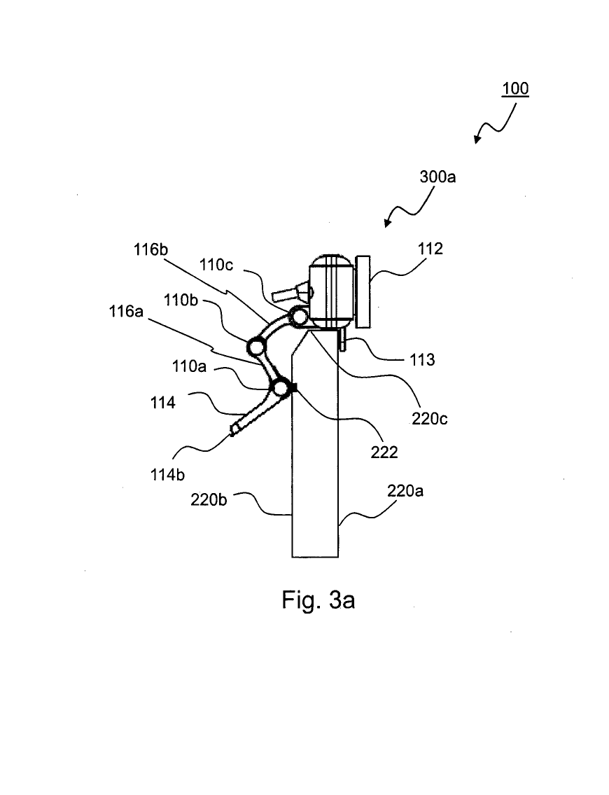

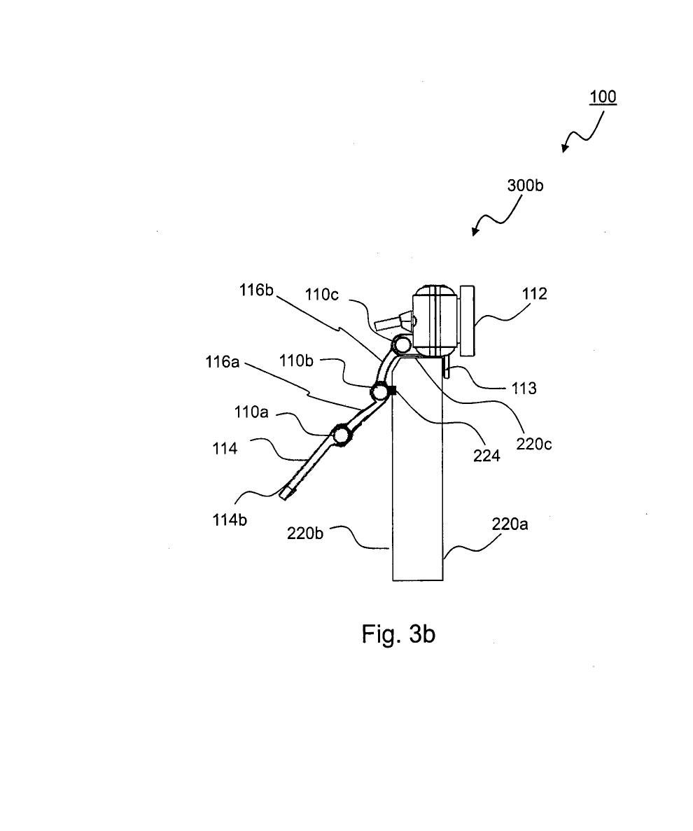

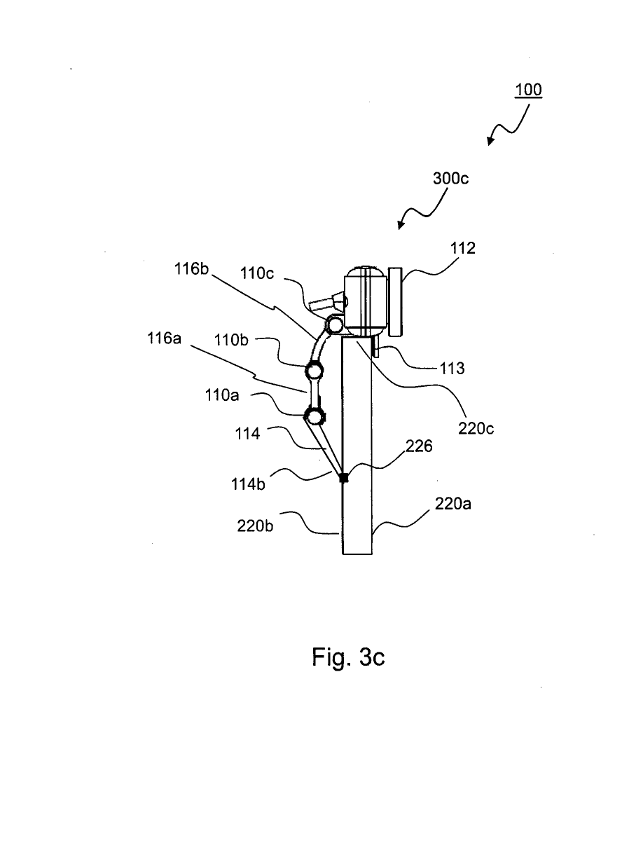

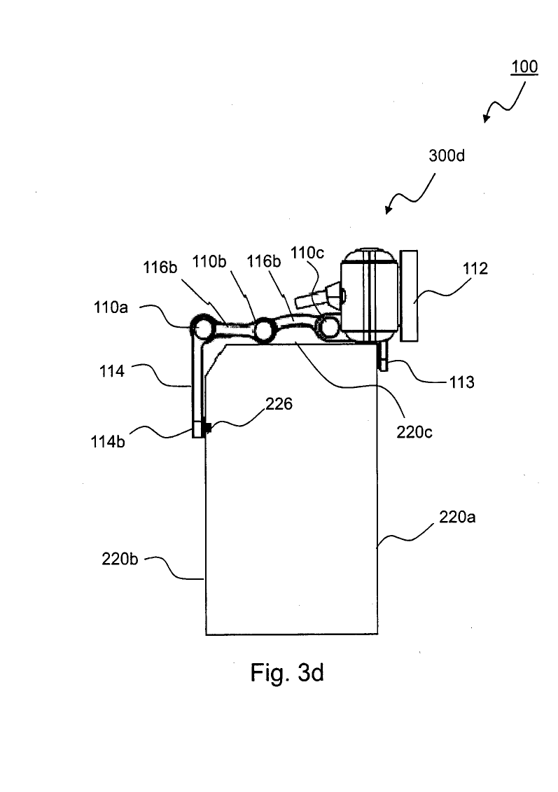

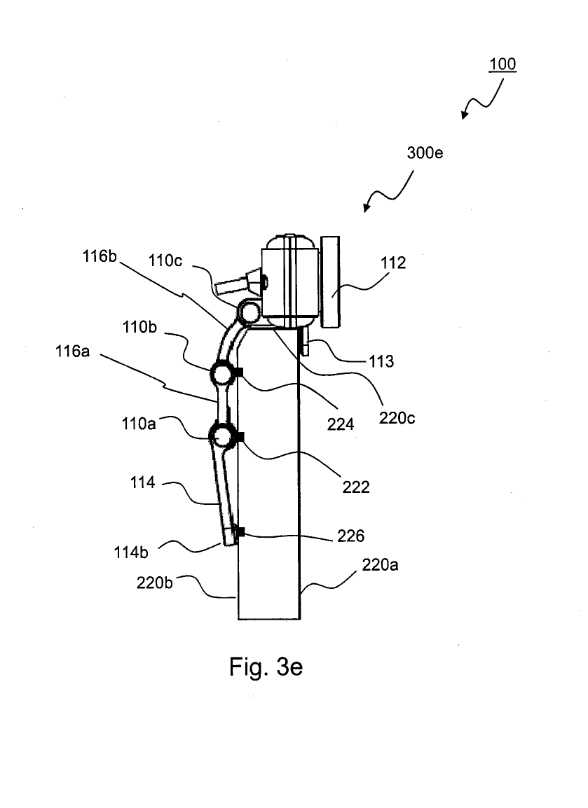

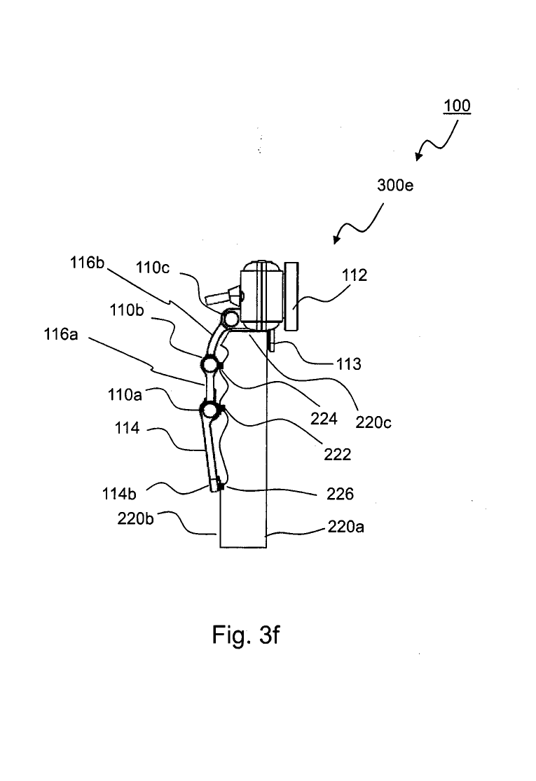

In another example, as shown in FIG. 2b, the assembly 100 can be in a grip configuration 200b such that the webcam 112 can be flexibly attached to an elevated surface 220. The elevated surface 220 can include a first face 220a and a second face 220b. The first face 220a opposes the second face 220b such that an edge 220c can be defined therebetween. In particular, the grip configuration 200b can be such that the webcam 112 can be flexibly attached to the elevated surface 220 via various grip positions, as will be discussed in further detail with reference to FIG. 3. In this regard, the grip configuration 200b can be associated with various grip positions.

Appreciably, via various grip positions, attachment of the webcam 112 to the elevated surface 220 need not necessarily be adversely affected or inhibited by shape and size of the elevated surface 220.

In general, when in the grip configuration 200b, the assembly 100 can be positioned such that the anchor portion 113 contacts the first face 220a. Furthermore, one or both of the first and second pivot joints 110a/110b can contact the second face 220b. Yet furthermore, the second end 114b of the base portion 114 can contact the second face 220b. In this regard, any of the first pivot joint 110a, the second pivot joint 110b and the second end 114b, or any combination thereof, can contact the second face 220b whilst the anchor portion 113 contacts the first face 220a. In this manner, the webcam 112 can be flexibly attached to the elevated surface 220 via various grip positions as will be discussed in further detail hereinafter with reference to FIG. 3a to FIG. 3f.

Contact at the second face 220b by the first pivot joint 110a can be associated with a first contact point 222 as shown in FIG. 3a, FIG. 3e and FIG. 3f. Contact at the second face 220b by the second pivot joint 110b can be associated with a second contact point 224 as shown in FIG. 3b, FIG. 3e and FIG. 3f. Contact at the second face 220b by the second end 114b of the base portion 114 can be associated with a third contact point 226 as shown in FIG. 3c, FIG. 3d, FIG. 3e and FIG. 3f.

Referring to FIG. 3a, a first exemplary grip position 300a is shown. In the first exemplary grip position 300a, the assembly 100 can be configured such that the anchor portion 113 contacts the first face 220a whilst the first pivot joint 110a contacts the second face 220b. The base portion 114 can be rotated relative to the first body portion 116a such that the second end 114b of the base portion 114 can be directed away from the second face 220b. Furthermore, the first and second body portions 116a/116b can be rotated relative to each other such that the second pivot point 110b is not contacting the second face 220b.

In this regard, the assembly 100 can be configured such that the support 110 contacts the elevated surface 220 via the first contact point 222. More specifically, the assembly 100 can be configured such that the support 110 contacts the second face 220b of the elevated surface 220 via the first contact point 222.

In the first exemplary grip position 300a, preferably, the third pivot joint 110c can be positioned over or adjacent the edge 220c. In one example, the third pivot joint 110c can be positioned such that it is resting on the edge 220c. In another example, the third pivot joint 110c can be positioned such that it is over, but not contacting and thus suspended from, the edge 220c.

Referring to FIG. 3b, a second exemplary grip position 300b is shown. In the second exemplary grip position 300b, the assembly 100 can be configured such that the anchor portion 113 contacts the first face 220a whilst the second pivot joint contacts 110b the second face 220b. The base portion 114 can be rotated relative to the first body portion 116a such that the second end 114a of the base portion 114 is directed away from the second face 220b. Additionally, the first body portion 116a can be rotated relative to the second body portion 116b such that the first joint portion 110a can be directed away from the second face 220b.

In this regard, the assembly 100 can be configured such that the support 110 contacts the elevated surface 220 via the second contact point 224. More specifically, the assembly 100 can be configured such that the support 110 contacts the second face 220b of the elevated surface 220 via the second contact point 224.

In the second exemplary grip position 300b, preferably, the third pivot joint 110c can be positioned over or adjacent the edge 220c. In one example, the third pivot joint 110c can be positioned such that it is resting on the edge 220c. In another example, the third pivot joint 110c can be positioned such that it is over, but not contacting and thus suspended from, the edge 220c.

Referring to FIG. 3c, a third exemplary grip position 300c is shown. In the third exemplary grip position 300c, the assembly 100 can be configured such that the anchor portion 113 contacts the first face 220a whilst the second end 114a of the base portion 114 contacts the second face 220b. The first and second body portions 116a/116b can be rotated in a manner such that the first and second pivot joints 110a/110b do not contact the second face 220b. In this regard, the assembly 100 can be configured such that the support 110 contacts the elevated surface 220 via the third contact point 226. More specifically, the assembly 100 can be configured such that the support 110 contacts the second face 220b of the elevated surface 220 via the third contact point 226.

In the third exemplary grip position 300c, preferably, the third pivot joint 110c can be positioned over or adjacent the edge 220c. In one example, the third pivot joint 110c can be positioned such that it is resting on the edge 220c. In another example, the third pivot joint 110c can be positioned such that it is over, but not contacting and thus suspended from, the edge 220c.

Referring to FIG. 3d, a fourth exemplary grip position 300d is shown. In the fourth exemplary grip position 300d, the assembly 100 can be configured such that the anchor portion 113 contacts the first face 220a whilst the second end 114b of the base portion 114 contacts the second face 220b.

In this regard, as with the third exemplary grip position 300c, the assembly 100 can be configured such that the support 110 contacts the elevated surface 220 via the third contact point 226. More specifically, the assembly 100 can be configured such that the support 110 contacts the second face 220b of the elevated surface 220 via the third contact point 226.

Additionally, in the fourth exemplary grip position 300d, one or both of the first and second pivot joints 110a/110b can be positioned either over the edge 220c or adjacent the edge 220c. Similarly, the third pivot joint 110c can be positioned over or adjacent the edge 220c. In one example, the first, second and third pivot joints 110a/110b/110c can be positioned such that they are positioned over the edge 220c. In another example, the first, second and third pivot joints 110a/110b/110c can be positioned such the first pivot joint 110a is adjacent the edge 220c whereas the second and third pivot joints 110b/110b are positioned over the edge 220c.

Referring to FIG. 3e and FIG. 3f, a fifth exemplary grip position 300e is shown. In the fifth exemplary grip position 300e, the assembly 100 can be configured such that the anchor portion 113 contacts the first face 220a whilst the first and second pivot joints 110a/110b, and the second end 114b of the base portion 114 contact the second face 220b.

In this regard, the assembly 100 can be configured such that the support 110 contacts the elevated surface 220 via the first, second and third contact points 222/224/226. More specifically, the assembly 100 can be configured such that the support 110 contacts the second face 220b of the elevated surface 220 via the first, second and third contact points 222/224/226.

In one example, as shown in FIG. 3e, where the second face 220b is a substantially planar surface, the first and second body portions 116a/116b and the base portion 114 can be rotated relative to each other such that the first and second pivot joints 110a/110b and the second end 114b of the base portion 114 contact the second face 220b.

In another example, as shown in FIG. 3f, where the second face 220b is an irregular surface, the first and second body portions 116a/116b and the base portion 114 can be rotated relative to each other such that the first and second pivot joints 110a/110b and the second end 114b of the base portion 114 contact the second face 220b.

Other grip positions (not shown) can also be useful.

In one further exemplary grip position, the assembly 100 can be configured such that the anchor portion 113 contacts the first face 220a whilst the first and second pivot joints 110a/110b contact the second face 220b. Additionally, the base portion 114 can be rotated relative to the first body portion 116a such that the second end 114b of the base portion 114 can be directed away from the second face 220b. In this regard, the assembly 100 can be configured such that the support 110 contacts the elevated surface 220 via the first and second contact points 222/224. More specifically, the assembly 100 can be configured such that the support 110 contacts the second face 220b of the elevated surface 220 via the first and second contact points 222/224.

In another further exemplary grip position, the assembly 100 can be configured such that the anchor portion 113 contacts the first face 220a whilst the first pivot joint 110a and the second end 114b of the base portion 114 contact the second face 220b. The first and second body portions 116a/116b can be rotated in a manner such that the second pivot joint 110b does not contact the second face 220b. In this regard, the assembly 100 can be configured such that the support 110 contacts the elevated surface 220 via the first and third contact points 222/226. More specifically, the assembly 100 can be configured such that the support 110 contacts the second face 220b of the elevated surface 220 via the first and third contact points 222/226.

In yet a further exemplary grip position, the assembly 100 can be configured such that the anchor portion 113 contacts the first face 220a whilst the second pivot joint 110b and the second end 114b of the base portion 114 contact the second face 220b. The first and second body portions 116a/116b can be rotated in a manner such that the first pivot joint 110a does not contact the second face 220b. In this regard, the assembly 100 can be configured such that the support 110 contacts the elevated surface 220 via the second and third contact points 224/226. More specifically, the assembly 100 can be configured such that the support 110 contacts the second face 220b of the elevated surface 220 via the second and third contact points 224/226.

Appreciably, via the various grip positions, as exemplified by the foregoing with reference to FIG. 3, the assembly 100 can be capable of facilitating attachment of the webcam 112 to the elevated surface 220 in a flexible manner. More specifically, the support 110 is capable of conforming to the second face 220b. In this manner, attachment of the webcam 112 to the elevated surface 220 need not necessarily be adversely affected or inhibited by shape and size of the elevated surface 220.

Furthermore, as mentioned earlier, the carrying portion 118 can be configured such that distance between the anchor portion 113 and the third pivot joint 110c is adjustable. Thus appreciably, flexibility in attachment of the webcam 112 to the elevated surface 220 can yet be further afforded.

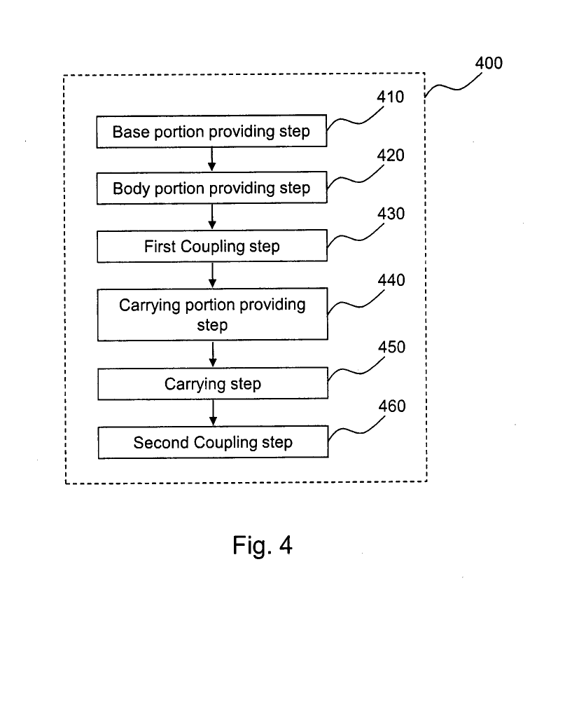

Referring to FIG. 4, a method 400 can be implemented in association with the assembly 100. The method 400 can be suitable for configuring the assembly 100 in a manner such that the assembly 100 can be in one of the stand configuration 200a and the grip configuration 200b. The method 400 includes a base portion providing step 410, a body portion providing step 420 and a first coupling step 430.

The method 400 can optionally include a carrying portion providing step 440. The method 400 can optionally further include a carrying step 450. The method 400 can yet optionally further include a second coupling step 460.

The base portion providing step 410 includes providing the base portion 114.

The body portion providing step 420 includes proving the body portion 116. Specifically, the first and second body portions 116a/116b can be coupled to each other in a manner such that they can be rotated relative to each other. The first and second body portions 116a/116b can be coupled to each other via the second pivot joint 110b.

The first coupling step 430 includes coupling the base and body portions 114/116 via the first pivot joint 110a. Specifically, the base portion 114 can be coupled to the first body portion 116a via the first pivot joint 110a in a manner such that the base portion 114 and the first body portion 116a can be rotated relative to each other.

The carrying portion providing step 440 can include providing the carrying portion 118. The carrying portion 118 can be coupled to the second body portion 116b such that the carrying portion 118 can be rotated relative to the second body portion 116b. The carrying portion 118 includes the platform portion 120 to which the anchor portion 113 can be coupled.

The carrying step 450 includes coupling a peripheral device such as the aforementioned webcam 112 to one of the body portion 116 and the carrying portion 118.

In one embodiment, the webcam 112 can be coupled to the second body portion 116b via the third pivot joint 110c in a manner such that the webcam 112 can be rotated relative to the second body portion 116b. Additionally, the anchor portion 113 can be coupled to the webcam 112.

In another embodiment, the carrying portion 118 can be coupled to the second body portion 116b via the third pivot joint 110c in a manner such that the carrying portion 118 can be rotated relative to the second body portion 116b. Additionally, the webcam 112 can be attached to the carrying portion 118.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. An assembly configurable for carrying a peripheral device in one of a stand configuration and a grip configuration, wherein when in the stand configuration the assembly is capable of supporting the peripheral device in a manner so as to elevate the peripheral device from a substantially horizontal surface, and wherein when in the grip configuration, the assembly is capable of supporting the peripheral device in a manner so as flexibly attach the peripheral device to an elevated surface, the assembly comprising:
a support configurable for carrying the peripheral device, the support comprising:
a base portion having a first end and a second end opposing the first end; and
a body portion rotatably coupled to the base portion, the body portion having a first body portion and a second body portion rotatably coupled to the first body portion, the first body portion being rotatably coupled to the first end of base portion,
wherein when in the stand configuration, the assembly is configurable such that the support is capable of supporting the peripheral device in a manner so as to elevate the peripheral device from the horizontal surface and the base portion contacts the horizontal surface, and
wherein when in the grip configuration, the assembly is configurable such that the support contacts the elevated surface via at least one of a first contact point, a second contact point and a third contact point.

2. The assembly as in claim 1 wherein the support further comprises:
a first pivot joint via which the body portion is rotatably coupled to the base portion;
a second pivot joint via which the first and second body portions are rotatably coupled.

3. The assembly as in claim 2,
wherein when in the grip configuration, the assembly is configurable such that the support contacts the elevated surface via at least one of the first pivot joint, the second pivot joint and the second end of the base portion, and
wherein the first contact point is associable with contact of the elevated surface by the first pivot joint, the second contact point is associable with contact of the elevated surface by the second pivot joint and the third contact point is associable with contact of the elevated surface by the second end of the base portion.

4. The assembly as in claim 3 further comprising a carrying portion coupled to the support via a third pivot joint.

5. The assembly as in claim 4 wherein the carrying portion comprises a platform portion, and the assembly is configurable to carry the peripheral device in a manner such that the peripheral device is coupled to the platform portion.

6. The assembly as in claim 5 further comprising an anchor portion coupled to the carrying portion.

7. The assembly as in claim 6,
wherein the elevated surface comprises a first face and a second face opposing the first face in a manner such that an edge is defined therebetween, and
wherein when in the grip configuration, the anchor portion contacts the first face, and at least one of the second end of the base portion, the first pivot joint and the second pivot joint contact the second face.

8. The assembly as in claim 6, wherein the carrying portion is configurable in a manner such that distance between the anchor portion and the third pivot joint is adjustable.

9. The assembly as in claim 8,
wherein the carrying portion comprises a first part and a second part, the first and second parts being telescopically coupled in a manner such that the platform portion is of a sliding arrangement, and
wherein the first part is coupled to the third pivot joint and the anchor portion is coupled to the second part.

10. The assembly as in claim 9 wherein the second part is slidable one of to and from the first part in a manner such that distance between the third pivot joint and the anchor portion is adjustable.

11. The assembly as in claim 3 being configurable to carry the peripheral device in a manner such that the peripheral device is rotatably coupled to the second body portion via a third pivot joint.

12. The assembly as in claim 11 further comprising an anchor portion coupled to the peripheral device,
wherein the elevated surface comprises a first face and a second face opposing the first face in a manner such that an edge is defined therebetween, and
wherein when in the grip configuration, the assembly is configurable in a manner such that the anchor portion contacts the first face of the elevated surface, and at least one of the first pivot joint, the second pivot joint and the second end of the base portion contact the second face of the elevated surface.

13. A support configurable for carrying a peripheral device in a manner so as one of elevate the peripheral device from a substantially horizontal surface and flexibly attach the peripheral device to an elevated surface, the support comprising:
a base portion having a first end and a second end opposing the first end; and
a body portion rotatably coupled to the base portion, the body portion having a first body portion and a second body portion rotatably coupled to the first body portion, the first body portion being rotatably coupled to the first end of base portion,
wherein when elevating the peripheral device from the horizontal surface, the base portion contacts the horizontal surface, and
wherein when flexibly attaching the peripheral device to the elevated surface, the support contacts the elevated surface via at least one of a first contact point, a second contact point and a third contact point.

14. The support as in claim 13 further comprising:
a first pivot joint via which the body portion is rotatably coupled to the base portion;
a second pivot joint via which the first and second body portions are rotatably coupled.

15. The support as in claim 14,
wherein when in the grip configuration, the support contacts the elevated surface via at least one of the first pivot joint, the second pivot joint and the second end of the base portion, and
wherein the first contact point is associable with contact of the elevated surface by the first pivot joint, the second contact point is associable with contact of the elevated surface by the second pivot joint and the third contact point is associable with contact of the elevated surface by the second end of the base portion.

16. The support as in claim 14 wherein the peripheral device is rotatably coupled to the second body portion via a third pivot point.

17. The support as in claim 13 further comprising a carrying portion, the carrying portion being rotatably coupled to the second body portion via a third pivot joint, the carrying portion having a platform portion to which an anchor portion is coupled.

18. The support as in claim 17,
wherein the platform portion comprises a first part and a second part, the first and second parts being telescopically coupled in a manner such that the platform portion is of a sliding arrangement, and
wherein the first part is coupled to the third pivot joint and the anchor portion is coupled to the second part.

19. The support as in claim 18 wherein the second part is slidable one of to and from the first part in a manner such that distance between the third pivot joint and the anchor portion is adjustable.

20. A support configurable for carrying a peripheral device in a manner so as one of elevate the peripheral device from a substantially horizontal surface and flexibly attach the peripheral device to an elevated surface, the support comprising:
a base portion having a first end and a second end opposing the first end;
a body portion rotatably coupled to the base portion via a first pivot joint, the body portion having a first body portion and a second body portion rotatably coupled to the first body portion via a second pivot point, the first body portion being rotatably coupled to the first end of base portion; and
a carrying portion rotatably coupled to the second body portion via a third pivot joint,
wherein when elevating the peripheral device from the horizontal surface, the base portion contacts the horizontal surface, and
wherein when flexibly attaching the peripheral device to the elevated surface, at least one of the first pivot joint, the second pivot joint and the second end of the base portion contact the elevated surface.
